(19) United States
(12) Patent Application Publication
(10) Pub. No.: US 2026/0003830 A1
(43) Pub. Date: Jan. 1, 2026

(54) INFORMATION PROCESSING SYSTEM AND METHOD FOR CONTROLLING INFORMATION PROCESSING SYSTEM

(71) Applicant: Hitachi Vantara, Ltd., Yokohama-shi (JP)

(72) Inventors: Ai SATOYAMA, Tokyo (JP); Akira DEGUCHI, Tokyo (JP)

(21) Appl. No.: 19/070,633

(22) Filed: Mar. 5, 2025

(30) Foreign Application Priority Data
Jun. 28, 2024 (JP) 2024-105359

(51) Int. Cl. G06F 16/182; G06F 16/18

(52) U.S. Cl. CPC G06F 16/184; G06F 16/1815

(57) ABSTRACT

A first journal group including a primary volume and a first journal volume and a second journal group including a secondary volume and a second journal volume are set in a consistency holding group. Journal processing is performed while ensuring consistency of replication between the first journal group and the second journal group. The second journal group is arranged for each node in which the secondary volume of the consistency holding group is arranged. The secondary volume is arranged in each node in the second storage system based on a usage status of a resource of each node in the second storage system and the number of nodes in which the secondary volume in the consistency holding group is arranged.

### CROSS-REFERENCE TO RELATED APPLICATION

The present application claims priority from Japanese application JP2024-105359, filed on June 28, 2024, the content of which is hereby incorporated by reference into this application.

### BACKGROUND OF THE INVENTION

### 1. Field of the Invention

The present invention relates to an information processing system and a method for controlling the information processing system.

### 2. Description of Related Art

A disaster recovery (DR) technique is known in which data is multiplexed and held in a remote site (secondary site) in preparation for data loss in a primary site when a large-scale disaster such as an earthquake or a fire occurs. Storage operation in a hybrid cloud environment has progressed, and cases where a DR environment for data of an on-premise storage system is configured in a cloud have increased.

A distributed storage system such as a software defined storage (SDS) is also used on the cloud. A DR environment is configured in the distributed storage system. The distributed storage system includes a large number of nodes, and when a volume is to be created, the volume is created by automatically selecting a node having a free capacity. In order to level a load on the node in consideration of an IO load on each volume and a specification of the node, there is a technique of PTL 1.

PTL 1 describes that "In a distributed storage system 1, a volume classifier 300 classifies a plurality of volumes into a plurality of groups based on a fluctuation cycle of a load in each volume. A processor (resource classifier 400) calculates a total load obtained by summing loads of the plurality of volumes on the same node in the group at each time, and calculates a group load based on a peak of the total load. A processor (rebalancer 500) of any node calculates a group load on a movement destination node when a movement candidate volume in rebalancing for moving a volume between nodes is moved from a movement source node to the movement destination node, determines a volume to be moved in the rebalancing and a movement destination volume based on the calculated group load on the movement destination node, and executes the rebalancing.".

### Citation List

### Patent Literature

PTL 1: JP2021-197010A

### SUMMARY OF THE INVENTION

However, the related art disclosed in PTL 1 does not consider a case where a DR environment is configured between the on-premise storage and the distributed storage system by the DR technique .

In a DR environment between the on-premise storage system and the distributed storage system, a volume (copy destination volume) is created in any node of the distributed storage system with respect to a volume (copy source volume) in the on-premise storage system to conFIGURE a DR relationship. At this time, when the copy destination volume is created by being distributed to a plurality of nodes of the distributed storage system, the number of journal groups for managing an update order increases, a processing efficiency deteriorates, and a performance deteriorates.

Therefore, an object of the invention is to reduce the number of nodes by limiting distribution of copy destination volumes, and to improve a performance by reducing an overhead of journal processing.

In order to achieve the above object, a typical information processing system of the invention includes: a first storage system including a node that provides a primary volume to a host; and a second storage system including a plurality of nodes that hold a secondary volume that is a replication of the primary volume. A consistency holding group is formed which is defined such that a plurality of sets of the primary volume and the secondary volume are provided and data in a plurality of the primary volumes written to the plurality of primary volumes with consistency is replicated to a plurality of the secondary volumes with consistency ensured. The replication is performed by journal processing using a first journal volume provided in the same node as the primary volume and a second journal volume provided in the same node as the secondary volume. In the consistency holding group, a first journal group including the primary volume and the first journal volume and a second journal group including the secondary volume and the second journal volume are set, and the journal processing is performed while ensuring consistency of the replication between the first journal group and the second journal group. The second journal group is arranged for each node in which the secondary volume of the consistency holding group is arranged. The secondary volume is arranged in each node of the second storage system based on a usage status of a resource of each node of the second storage system and the number of nodes in which the secondary volume in the consistency holding group is arranged.

A typical method for controlling an information processing system according to the invention is provided. The information processing system includes a first storage system including a node that provides a primary volume to a host and a second storage system including a plurality of nodes that hold a secondary volume that is a replication of the primary volume. The method includes forming a consistency holding group which is defined such that a plurality of sets of the primary volume and the secondary volume are provided and data in a plurality of the primary volumes written to the plurality of primary volumes with consistency is replicated to a plurality of the secondary volumes with consistency ensured. The replication is performed by journal processing using a first journal volume provided in the same node as the primary volume and a second journal volume provided in the same node as the secondary volume. In the consistency holding group, a first journal group including the primary volume and the first journal volume and a second journal group including the secondary volume and the second journal volume are set, and the journal processing is performed while ensuring consistency of the replication between the first journal group and the second journal group. The second journal group is arranged for each node in which the secondary volume of the consistency holding group is arranged. The secondary volume is arranged in each node of the second storage system based on a usage status of a resource of each node of the second storage system and the number of nodes in which the secondary volume is arranged in the consistency holding group.

According to the invention, the performance can be improved by limiting the distribution of the copy destination volume. Problems, configurations, and effects other than those described above will become apparent by the following description of embodiments.

### BRIEF DESCRIPTION OF THE DRAWINGS

FIG. 1 is a block diagram showing a configuration example of hardware of an information processing system 1 according to Embodiment 1 of the invention.

FIG. 2 is a diagram showing a configuration of software.

FIG. 3 is a diagram showing control information stored in a memory 222.

FIG. 4 is a diagram showing an example of volume information 410.

FIG. 5 is a diagram showing an example of CTG information 420.

FIG. 6 is a diagram showing an example of DR management information 430.

FIG. 7 is a diagram showing an example of node information 440.

FIG. 8 is a diagram showing an example in which a copy destination volume is distributed to a plurality of nodes.

FIG. 9 is a flowchart showing processing procedure example of processing for selecting a copy destination volume.

FIG. 10 is a diagram showing an example in which a copy destination volume is distributed to a plurality of nodes (part 1) .

FIG. 11 is a diagram showing an example in which a copy destination volume is distributed to a plurality of nodes (part 2) .

FIG. 12 is a diagram showing an example in which a copy destination volume is distributed to a plurality of nodes (part 3) .

FIG. 13 is a flowchart showing a processing procedure example of processing for moving the copy destination volume.

FIG. 14 is a flowchart showing a processing procedure example of processing for determining a timing of executing data migration.

FIG. 15 is a flowchart showing a processing procedure example of another processing for selecting a copy destination volume.

### DESCRIPTION OF EMBODIMENTS

Hereinafter, embodiments according to the invention will be described with reference to the drawings.

However, the following embodiments are examples illustrating the invention, but the invention is not limited to the embodiments, and any application example that matches the idea of the invention is within the technical scope of the invention. The invention can be implemented in various other forms. Unless otherwise specified, each component may be single or plural.

In the following description, information of the invention will be described by an expression "XX information", but these pieces of information may be expressed by, for example, a data structure such as a "table", a "list", or a "database (DB)", or other data structures. In describing contents of each piece of information, expressions such as "identification information", an "identifier", a "first name", a "name", and an "ID" can be used, and these expressions can be replaced with one another.

In the following description, processing may be described by executing a program, the program may be executed by at least one processor (for example, a CPU) to execute predetermined processing using a storage resource (for example, a memory) and/or an interface device (for example, a communication port) as appropriate, and thus an entity of the processing may be the processor. Similarly, the entity of the processing performed by executing the program may be a controller, an apparatus, a system, a computer, a node, a storage system, a storage apparatus, a server, a management computer, a client, or a host including the processor. The entity (for example, the processor) of the processing performed by executing the program may include a hardware circuit that performs a part or all of the processing, or may be modularized. For example, the entity of the processing performed by executing the program may include a hardware circuit that executes encryption and decryption or compression and decompression. Various programs may be installed in each computer based on a program distribution server or a storage medium. The processor operates as a functional unit that implements a predetermined function by operating according to the program. An apparatus and a system including the processor are an apparatus and a system including such a functional unit. The "read/write processing" may be referred to as "read/write processing" or "update processing".

In the drawings, the same reference numerals are given to the same configurations. In the drawings, when elements of the same type are described without distinction, reference numerals or common numbers in the reference numerals are used, and when elements of the same type are described by distinction, the reference numerals of the elements may be used or IDs assigned to the elements may be used instead of the reference numerals.

### Embodiment 1

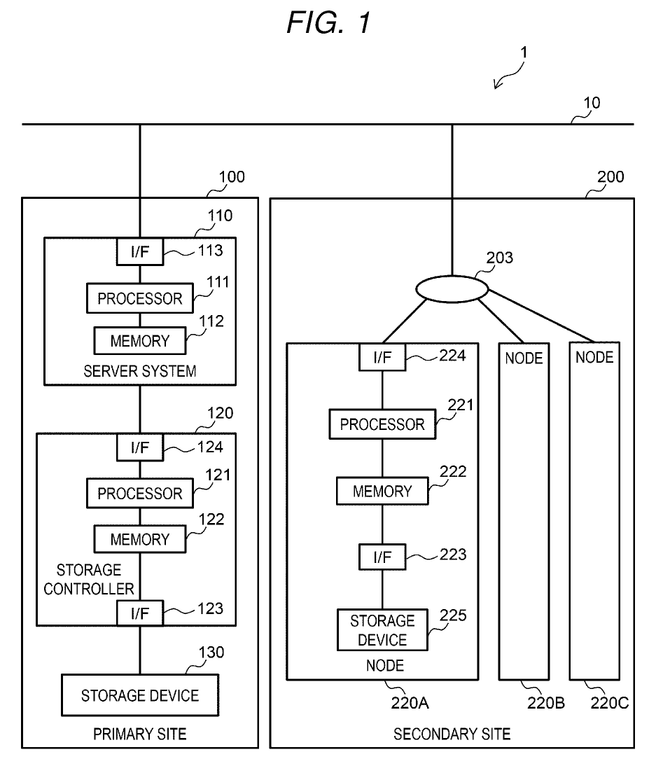

FIG. 1 is a block diagram showing a configuration example of hardware of an information processing system 1 according to Embodiment 1 of the invention.

As shown in FIG. 1, the information processing system 1 is a disaster recovery system that provides a disaster recovery configuration. The information processing system 1 includes a primary site 100 and a secondary site 200, which are connected to each other via a network 10 (typically, an Internet Protocol (IP) network). In the embodiment, the disaster recovery configuration in which an on-premise-based storage system (on-premise storage) is used for the primary site 100 and a distributed storage system is used for the secondary site 200 will be described, and the essence of the invention does not change even when at least the secondary site 200 may be a distributed storage system and the primary site 100 is a distributed storage system. For simplicity of description, "disaster recovery" may be referred to as DR. The distributed storage system may be a cloud-based storage system (cloud storage) in a cloud.

The primary site 100 is a storage system that provides a service of an application to a user (customer) in a normal state, is formed of a so-called on-premise storage system, and specifically includes a server system 110, a storage controller 120, and a storage device 130.

The server system 110 includes a processor 111, a memory 112, and a network interface (I/F) 113, and is connected to the network 10 via the I/F 113. The storage controller 120 includes a memory 122, a front-end network interface (I/F) 124, a back-end storage interface (I/F) 123, and a processor 121 connected thereto. The storage controller 120 is connected to the server system 110 via the I/F 124, and is connected to the storage device 130 via the I/F 123. The storage device 130 is a storage device that physically stores data. In the server system 110 and the storage controller 120, the memory and the processor are made redundant.

The memory 122 stores information and one or more programs. By executing the one or more programs, the processor 121 provides a storage region (here, a logical volume (for example, a volume created from a storage pool obtained by virtualizing a capacity of the storage device 130) will be described, but the essence of the invention does not depend on this) to the server system 110, and processes an input/output (I/O) request such as a write request or a read request from the server system 110. For example, the server system 110 receives a write request or a read request designating a volume from a host apparatus (host) used by a user (customer), and transmits the request to the storage controller 120. The storage controller 120 reads and writes data from and to the volume in the storage device 130 in response to the write request or the read request.

The storage controller 120 and the storage device 130 may be configured as one storage system. For example, there are a high-end storage system based on redundant array of independent (or inexpensive) disks (RAID) technique, a storage system using a flash memory, and the like.

A configuration of the storage device 130 may be, for example, a distributed storage system.

The storage device 130 may be a hyper-converged infrastructure (HCI) storage system, for example, a system having a function as a host system that issues an I/O request (for example, an execution body (for example, a virtual machine or a container) of an application that issues an I/O request) and a function as a storage system that processes the I/O request (for example, an execution body (for example, a virtual machine or a container) of storage software). The configuration of the storage device 130 is an example and is not limited thereto.

The secondary site 200 is a disaster recovery site (DR site) that holds data of the primary site 100 in preparation for data loss in the primary site 100 when a large-scale disaster such as an earthquake or a fire occurs, and recovers data and services of the primary site 100 using the held data when a failure and the like occurs in the primary site 100. In the information processing system 1 according to the embodiment, the secondary site 200 is typically a distributed storage system. The secondary site 200 may be a distributed storage system belonging to a public cloud. The secondary site 200 may be a cloud storage system that belongs to a public cloud and is a base of a cloud storage service provided by a cloud vendor. Examples of the cloud storage service include Amazon Web Services (AWS) (registered trademark), Azure (registered trademark), Google Cloud Platform (registered trademark), and the like. The cloud storage system used for the secondary site 200 may be a storage system belonging to another type of cloud (for example, a private cloud) instead of the public cloud.

The secondary site 200 is implemented by a distributed storage system and is connected to the network 10.

The data transfer between the storage device 130 in the primary site 100 and the distributed storage system in the secondary site 200 is a method of direct transfer via the network 10 in the information processing system 1 shown in FIG. 1, but is not limited thereto, and may be a method of transfer using another network path or line for data transfer. Any type of network or line is not essential to the invention.

In the distributed storage system, a plurality of storage computers each including a storage device and a processor are connected to one another via a network. Each computer is also called a node in the network. Each computer forming the distributed storage system is also particularly called a storage node, and each computer forming a compute cluster is also called a compute node.

The distributed storage system according to the embodiment will be described in detail.

In the distributed storage system, a plurality of nodes 220A to 220C (collectively referred to as nodes 220), which are storage nodes, are connected to one another via a network 203. A hardware structure of each storage node is not particularly limited, and for example, the node 220A includes a processor (central processing unit) 221, a memory 222, a network interface 224, a drive interface 223, a storage device 225, and the like. These are connected by an internal network. The node 220A is connected to the network 203 via the network interface 224 and communicates with the other storage nodes (nodes 220B to 220C). Depending on the configuration of the network 203, the distributed storage system may be formed by the nodes 220 at geographically sufficiently distant locations.

In the embodiment, all the nodes 220A to 220C forming the distributed storage system are exemplified as storage nodes, but the nodes forming the distributed storage system are not limited to the storage nodes, and may include some nodes functioning as compute nodes.

An operating system (OS) for managing and controlling the storage node is installed in the storage node forming the distributed storage system, and the distributed storage system is implemented by causing storage software having a function of the storage system to operate thereon. The storage software can form a distributed storage system even by operating in a form of a container on the OS. The container is a mechanism for packaging one or more pieces of software and configuration information. It is also possible to form a distributed storage system by installing a hypervisor on the storage node and operating the OS and software as a virtual machine (VM).

The invention is also applicable to HCT. The HCT is a system in which, in addition to storage software, an application, middleware, management software, and a container are operated on an OS or a hypervisor installed in each node to enable one node to perform a plurality of pieces of processing.

The distributed storage system provides a host with a storage pool and a logical volume (also simply called a volume) in which capacities of storage devices on a plurality of storage nodes are virtualized.

As another embodiment, the information processing system 1 may include a storage management system. The storage management system may be a part of components of the primary site or the secondary site, or a dedicated management appliance or management terminal. The management apparatus and the management terminal may be connected to the network 10.

For example, the storage management system is a computer system (one or more computers) that manages a configuration of a storage region of the storage device 130 and the storage device 225, and can be instructed by the user (or administrator) to set the storage device 130 and the storage device 225. Alternatively, the user can instruct to set the storage device 130 and the storage device 225 via the management terminal. The storage management system may be separate apparatuses for the storage system of the primary site and for the storage system of the secondary site.

An administrator of the distributed storage system can perform processing such as creation, deletion, and movement of a volume by issuing a management command to a distributed storage via the network. The distributed storage system can notify the administrator or a management tool of a state of the distributed storage system, such as a usage status of a drive and a usage status of a processor of the distributed storage system, by providing information transmitted by the distributed storage system via the network.

For example, the storage management system can configure a DR environment, in which the secondary site 200 executes a VM (VM 252) and an application (application 253) the same as that of the primary site 100, by managing resource configuration information and application information of the primary site 100 and instructing the secondary site 200 side.

The resource configuration information and the application information of the primary site 100 may be stored in the memory 112 of the server system 110 or the storage device 130, or the storage management system may acquire the information therefrom.

With the above configuration, data of the storage device 130 is copied and stored in the storage device 225 in the distributed storage system, the volume in the storage device 130 is restored in the distributed storage system using the copied data, the information processing system 1 having the DR configuration can be implemented by the primary site 100 including the storage device 130 and the secondary site 200 including the distributed storage system.

When a volume (copy destination volume) is created in any node of the secondary site 200 which is a distributed storage system with respect to a volume (copy source volume) in the storage system of the primary site 100 to configure a DR relationship, there are some cases where the copy destination volume is created by being distributed to a plurality of nodes of the distributed storage system. Examples of this case include the following (1) to (4).

(1) When a copy destination volume is created for a certain copy source volume and is caused to belong to a consistency time group (CTG), and then a copy destination volume is created for another copy source volume in the same manner as described above and is added to the CTG, when a copy destination volume is created in a node different from a node in which the previously created copy destination volume is created, the copy destination volume in the same CTG is distributed to a plurality of nodes.

(2) When copy destination volumes of a plurality of copy source volumes belonging to the CTG are collectively created, if a free capacity of the selected node is smaller than a total capacity of all the volumes, it is necessary to create a copy destination volume in another node due to the shortage of the free capacity, and thus the copy destination volume is distributed to the plurality of nodes.

(3) When copy destination volumes of a plurality of copy source volumes belonging to the CTG are collectively created, in order to prevent a load, such as initial volume data full copy processing, from being applied to a specific node, the copy destination volume is distributed to the plurality of nodes.

(4) When an existing volume already created in the distributed storage system is used as a copy destination volume, the copy destination volume in the same CTG is distributed to the plurality of nodes when the nodes of the existing volume are different.

The CTG is a group of sets of volumes that perform copying while maintaining consistency of data over a plurality of volumes. Operation is divided for each host application group, and volumes of the same task are managed by belonging to the same CTG.

When copy processing is performed in the DR environment, a write order (update order) from the host is managed in a journal. A journal group is a set of volumes formed of one or more data volumes and journal volumes, and journal processing is executed in journal group (JNLG) units. First, it is necessary to create a JNLG by volume registration.

Since consistency of volumes belonging to the same journal volume is guaranteed, the JNLG belongs to one CTG.

Since the nodes of the distributed storage system independently perform processing operations, a JNLG is provided for each node.

When the nodes of the copy destination volume in the CTG are distributed, the number of JNLGs in the CTG increases because the JNLG is provided for each node. When the number of nodes in a copy destination distributed storage system is N, if the copy destination volume is distributed to N nodes, the number of JNLGs increases to N times in the worst case. When the number of JNLGs increases, since JNL processing that has been collectively performed in the JNLG is performed for each JNLG, a processing efficiency deteriorates and a performance deteriorates.

Therefore, in the information processing system 1, when the copy destination volume is distributed to the plurality of nodes in the distributed storage system, control for reducing the number of distributed nodes is executed to reduce an overhead of the JNL processing. Details thereof will be described below.

An example of an operation image of the information processing system 1 will be described below. In the primary site 100, one or more virtual machines (VM) are created on a server (server group) including one or more server systems 110. On each VM, an application designated by the user is executed. The application designated by the user is an application that provides a service to the user, and by designation of a service used by the user, an application corresponding to the service is designated.

An operating system (OS) for managing and controlling a storage device (in the distributed storage system, an OS for managing and controlling a storage node) is installed, and storage software having a function of the storage system is operated thereon. The data is stored in a storage region in the storage device 130 via a storage pool in which the capacity of the storage device is virtualized.

In the node 220, a host OS for controlling hardware operates, and a hypervisor for operating one or more guest OS as a VM operates thereon.

A container runtime for operating one or more containers operates on each guest OS, and storage software and computing software operate thereon. In the above software stack, when the hypervisor has a function for controlling hardware, the host OS can be omitted. When it is not necessary to run each software on the VM, the hypervisor and the guest OS can be omitted, and at this time, the container runtime can be operated on the host OS. When the storage software and the computing software do not operate as a container, the container runtime can be omitted, and at this time, the storage software and the computing software can be directly operated on the guest OS or the host OS.

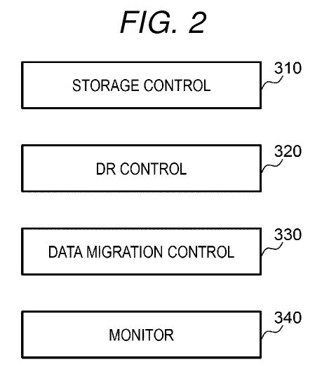

FIG. 2 is a schematic diagram showing a relationship between software (or control programs, modules, functions, and components) in the storage system of the primary site 100 and the distributed storage system of the secondary site 200. The software includes storage control 310, DR control 320, data migration control 330, and a monitor 340. The pieces of software can communicate with each other and transmit and receive information. Each software module is executed on the storage controller 120 of the storage system in the primary site 100. In the distributed storage system, each software module may be executed on the same node as the storage node 220, or may be on another node or another hardware component such as an apparatus, a terminal, or a circuit as long as it is a location where the distributed storage system can be accessed via the network 10. It is not necessary to implement all software on the same storage controller 120 and node 220. A form in which each piece of software is executed may be any method such as a process or a container.

The storage control 310 controls the storage device 130 and the storage device 225. For example, when an I/O request to the storage device 130 and the storage device 225 is issued, a location where data designated by the I/O request is stored in the storage device 130 is accessed, and the data is provided to the host. In the case of the distributed storage device of the secondary site 200, when the host issues the I/O request to any of the storage nodes, the distributed storage system transfers the I/O request to a storage node holding data designated by the I/O request, thereby providing the host with access to the data.

The DR control 320 has functions of instructing a DR environment configuration between the primary site 100 and the secondary site 200, forming a primary and a secondary corresponding to a VM and an application in the DR environment (determining a copy source volume and a copy destination volume, and managing a consistency time group (CTG) and a journal group (JNLG)), controlling data transfer of transferring the data stored in the storage device 130 of the primary site 100 to the secondary site 200, restoring a volume in the secondary site 200 from data copied in the secondary site 200, and the like.

The data migration control 330 has a function of determining a schedule and data movement for moving a copy destination volume to another node.

The monitor 340 monitors a load on each hardware element of the distributed storage system. The data migration control 330 refers to monitoring information from the monitor 340, determines a movement destination of a volume, and moves the volume.

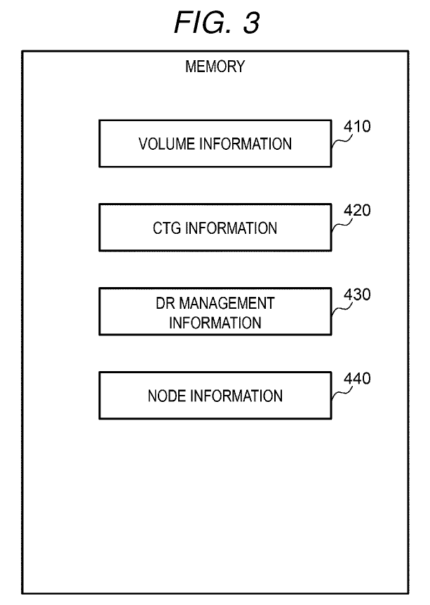

FIG. 3 shows control information stored in the memory 122 of the storage controller and the memory 222 of the node 220.

Specifically, the memory stores volume information 410, CTG information 420, DR management information 430, node information 440, and storage information 460. These pieces of information are appropriately accessed at the time of execution of processing by each piece of software shown in FIG. 2, and reference, reading, creation, writing, updating, and the like is performed.

These pieces of information may be included in the management apparatus.

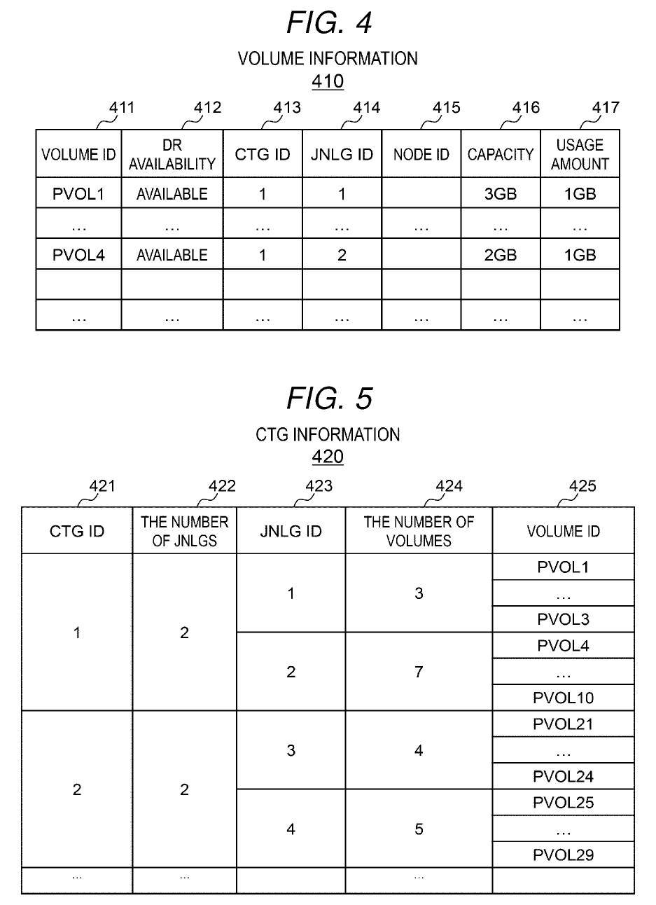

FIG. 4 is a diagram showing an example of the volume information 410. The volume information 410 is information on volumes stored in apparatuses of the storage devices 130 and 225. The volume information 410 includes a volume ID 411, a DR availability 412, a CTG ID 413, a JNLG ID 414, a node ID 415, a capacity 416, and a usage amount 417.

The volume ID 411 stores an identifier of a volume provided to the host. The DR availability 412 indicates whether the volume ID 411 has a copy destination volume based on the DR configuration. The volume information of the distributed storage system indicates whether a copy source volume is present. The CTG ID 413 indicates an identifier of a consistency time group (CTG) to which the volume ID 411 belongs, and the JNLG ID 414 indicates an identifier of a JNLG to which the volume ID 411 belongs. The node ID 415 is provided only in the case of the volume information of the distributed storage system, and indicates an identifier of a node to which the volume ID 411 is provided. The capacity 416 indicates a storage capacity of the volume ID 411. The usage amount 417 indicates an amount of data stored and used in the storage capacity.

FIG. 5 is a diagram showing an example of the CTG information 420. The CTG information 420 shown in FIG. 5 includes items of a CTG ID 421, the number of JNLGs 422, a JNLG ID 423, the number of volumes 424, and a volume ID 425.

CTG ID 421 is an identifier of a CTG implemented in the DR configuration of the information processing system 1. The number of JNLGs 422 is the number of JNLGs belonging to the CTG ID 421 and is a total number of JNLGs described in the JNLG ID 423. The JNLG ID 423 indicates an identifier of the JNLG belonging to the CTG ID 421. The number of volumes 424 is the number of volumes belonging to the JNLG volume ID 425, and is a total number of volumes described in the volume ID.

The CTG is a group for guaranteeing an update order over a plurality of volumes, and is a group formed by a plurality of volumes set in storage systems of the primary site and the secondary site of the DR configuration. By designating the CTG, the volumes can be collectively operated in CTG units.

For example, a plurality of volumes used for the same task are configured to belong to the same CTG.

The CTG may be created in some nodes among a plurality of nodes of the distributed storage system. For example, when the distributed storage system is formed of three nodes from node 1 to node 3, CTG1 may be formed of node 1 and node 2, and CTG2 may be formed of node 2 and node 3.

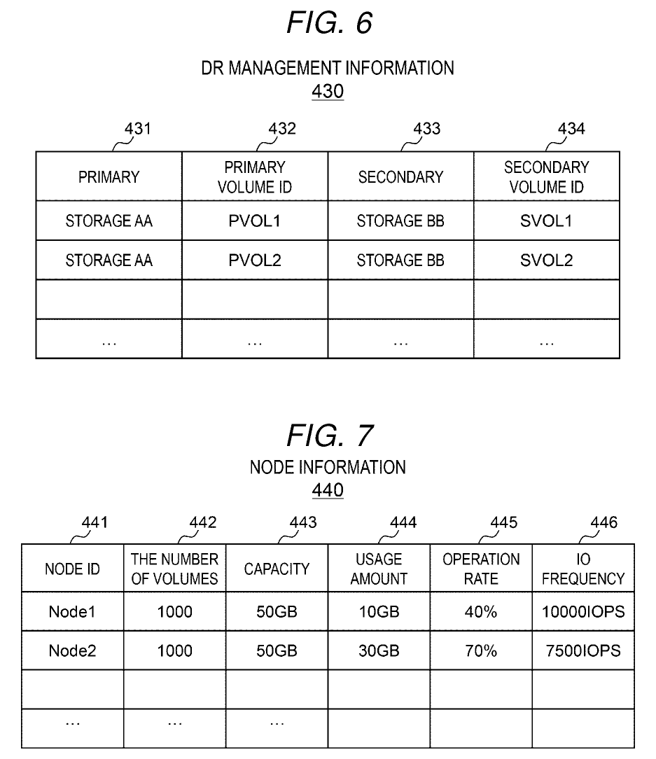

FIG. 6 is a diagram showing an example of the DR management information 430. The DR management information 430 includes information indicating a corresponding DR relationship in the DR environment in the information processing system 1. The DR management information 430 shown in FIG. 6 includes items of a primary 431, a primary volume ID 432, a secondary 433, and a secondary volume ID 434.

The primary 431 stores an identifier, for example, a serial number indicating a storage system forming the primary site 100 of the DR. The primary volume ID 432 stores an identifier of the volume of the primary site. The secondary 433 stores an identifier, for example, a serial number indicating a storage system forming the secondary site 200 of the DR in a form corresponding to the primary 431. The secondary volume ID 434 stores an identifier of the volume of the secondary site.

In the DR configuration, the volume in the primary site is called a copy source volume, and the volume in the secondary site is called a copy destination volume. The copy source volume may be denoted by PVOL, and the copy destination volume may be denoted by SVOL.

FIG. 7 is a diagram showing an example of the node information 440. The node information 440 is data indicating the configuration of the nodes 220 forming the distributed storage system. In the case of FIG. 7, the node information 440 includes data items of a node ID 441, a volume 442, a capacity 443, a usage amount 444, an operation rate 445, and an IO frequency 446. In the capacity 443, a total value of a drive capacity mounted on the target node 441 is described. In the usage amount 444, a sum of the capacities allocated to the volumes provided to the host among the storage device 225 that is a physical drive in the node 441 is described. The operation rate 445 indicates a usage rate of a processor in a node. The IO frequency 446 indicates, as a ratio, the number of read and write requests per unit time for the node.

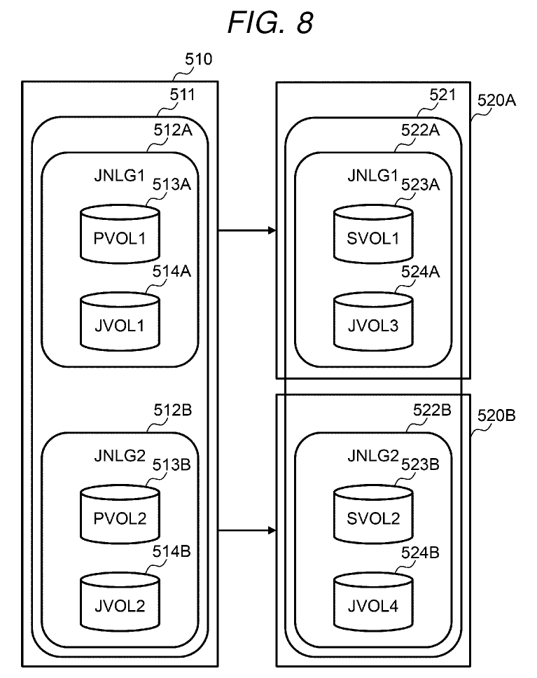

FIG. 8 shows an example in which copy destination volumes of DR in a CTG are distributed to a plurality of nodes. There is a volume 513 in a storage system 510 configured in the on-premises primary site 100. Here, two volumes 513A and 513B are used as the volume 513. Here, the distributed storage system includes two nodes 520A and 520B. The two volumes 513A and 513B are set as copy source volumes of the DR, and are copied to copy destination volumes 523A and 523B. The volume 513A and the volume 513B belong to the same CTG 511. The copy destination volume 523A and volume 523B also belong to the same CTG 521.

The volume 513A replicates data to the volume 523A in the node 520A, and the volume 513B replicates data to the volume 523B in the node 520B. A copy destination volume of a PVOL1 is an SVOL1, and a copy destination volume of a PVOL2 is an SVOL2. Copy processing from the on-premise storage system to the distributed storage system in the DR environment is performed using, for example, an asynchronous remote copy technique in the related art.

A journal group (JNLG) is used to manage a differential copy of data of the copy source volume and the copy destination volume. The JNLG is a set of volumes including one or more data volumes and journal volumes. The data volume is a copy source volume or a copy destination volume, and the journal volume is a volume in which write data from the host and information indicating a history related to the update of the data are stored. In the storage system of the primary site, when a write request is received, data is written to the data volume, journal data is written to the journal volume, and a response is returned to the server system. In a copy destination storage system of the secondary site, journal data is read from a journal volume of a copy source storage system asynchronously with the write request and is stored in its own journal volume. Then, the copy destination storage system restores the copied data to a copy destination data volume based on the stored journal data. As described above, the write order is managed such that the data can be restored. The journal processing is executed in JNLG units.

In FIG. 8, the volume 513 or 523 and the journal volume belong to a JNLG 512 or 522. Since nodes 520 of the distributed storage system operate on respective OSs, the JNLG is also set for each node. Since the storage system 510 sets a JNLG corresponding to a copy destination node, the storage system 510 is also provided with JNLGs corresponding to the number of distributed copy destination nodes. Since the volume 513A is copied to the volume 523A in the node 520A, the volume 513A belongs to a JNLG 512A. Since the volume 513B is copied to the volume 523B in the node 520B, the volume 513B belongs to a JNLG 512B.

If the copy destination volume is distributed to all the nodes of the distributed storage system in all the set CTGs, the number of JNLGs is necessary for one CTG for the number of nodes.

As described above, when the copy destination volume in the same CTG is distributed to a plurality of nodes, the problem is solved by reducing the number of distributed nodes. That is, by reducing the number of JNLGs in the CTG, the processing efficiency can be prevented from deteriorating and the performance can be improved.

A procedure for creating a configuration of FIG. 8 is executed by the DR control 320 as follows.

For the DR configuration of the DR management information 430 in FIG. 6, for example, the CTG1 is created and registered in the CTG information 420.

Here, when DR destinations are the node 520A and the node 520B, journal volumes JVOL3 (524A) and JVOL4 (524B) are created in the nodes 520A and 520B. The JVOL3 is registered in the JNLG1 of the node 520A, and the JVOL4 is registered in the JNLG2 of the node 520B. Journal volumes JVOL1 (514A) and JVOL2 (514B) are created in the storage system 510 of the DR source, and are registered in the JNLG1 and the JNLG2, respectively. The JNLG1 and the JNGL2 are registered in the CTG1.

When there is another CTG2, the same processing is performed. For example, a journal volume JVOL7 is created in the node 520A, and a journal volume JVOL8 is created in the node 520B. The JVOL7 is registered in a JNLG3, and the JVOL8 is registered in a JNLG4. Journal volumes JVOL5 and JVOL6 are created in the storage system 510 of the DR source, and are registered in the JNLG1 and the JNLG2, respectively. The JNLG3 and the JNGL4 are registered in the CTG2.

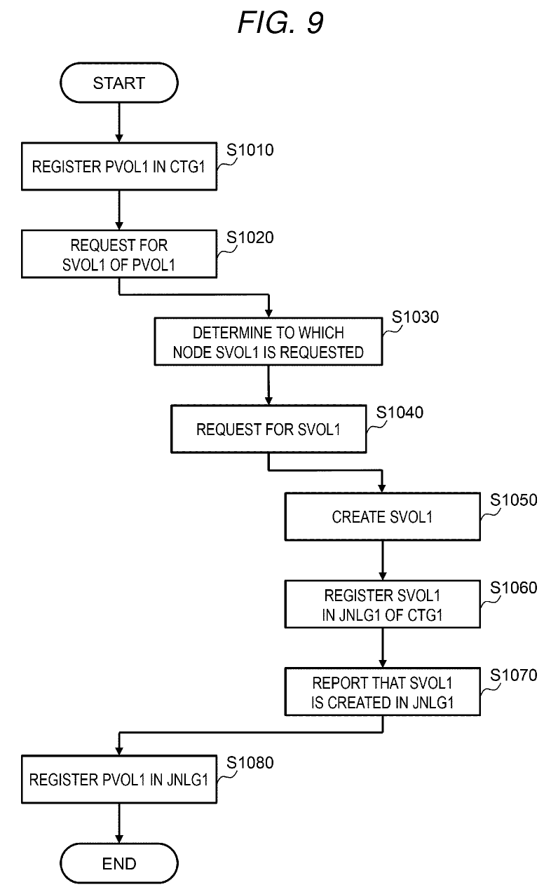

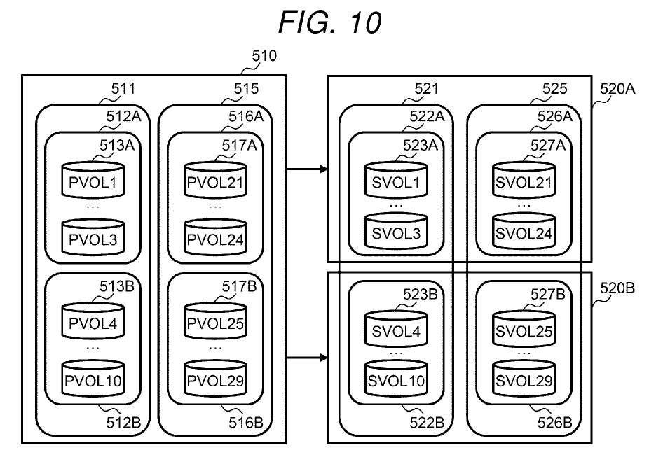

FIG. 9 shows a flowchart of processing for selecting a copy destination volume.

First, when the PVOL1 (513A) is a DR target volume, the copy source storage system 510 registers the PVOL1 in the CTG1 (S1010).

Then, the storage system 510 requests the distributed storage system to create the SVOL1 that is a copy destination volume of the DR of the PVOL1 (S1020).

The compute node of the distributed storage system receives the request, determines a node in which the SVOL1 is to be created (S1030), and transmits a creation request for an SVOL12 to the storage node 522 that is the determination result (S1040). As a method for selecting a node to which the request is transmitted, a node having a large free capacity among a storage capacity of the node or a node having a low operation rate of a processor in the node is selected. A node having a volume that has already been created and has not been used may be selected, and the unused volume may be set as the SVOL1.

The node 1 (520A) that has received the request creates the SVOL1 (S1050) and registers the SVOL1 as a copy destination of the PVOL1. The SVOL1 is registered in the JNLG1 of the CTG1 in the node (S1060).

The node 1 reports to the storage system 510 via the compute node that the SVOL1 is created in the JNLG1 (S1070).

The storage system 510 receives a JNLG ID in which the SVOL1 is created, and registers the PVOL in the received JNLG1 among the JNLGs in the CTG1 (S1080).

Similarly, in the case of the PVOL2 (513B) that is a DR target volume, the PVOL2 is registered in the CTG1. The distributed storage system is requested to create an SVOL that is a copy destination volume for the PVOL2. In this example, the node 2 (520B) receives the request and creates the SVOL, and registers the SVOL as a copy destination of the PVOL2. The SVOL is registered in the JNLG12 of the CTG1 in the node. The storage system 510 receives a JNLG ID and registers the PVOL in the received JNLG2 among the JNLGs in the CTG1.

Here, it is identified to which JNLG the PVOL is registered by receiving the JNLG ID from the DR copy destination, but the purpose is to register the PVOL and the SVOL in the same JNLG, and another method may be used.

For example, when the journal volume JVOL1 is created and registered in the CTG1 of the storage system 510 and the copy destination volume is created, the JNLG2 may be newly created at a timing when an SVOL is created in a node different from the previous node.

This will be described with reference to examples of FIGS. 10 to 12. Under the DR configurations of the storage system 510 and the distributed storage system including the node 520, two OTGs of the OTG 511 and a CTG 515 are managed in the storage system 510, and two CTGs of the CTG 521 and a CTG 525 are managed in the node 520 of the distributed storage system. The CTG 511 and the CTG 521 are managed as the same CTG. The CTG 515 and the CTG 525 are also the same CTG.

The copy source volume 513 belongs to the CTG 511, the volume 513A (PVOL1 to PVOL3 in the drawing) is copied to the copy destination volume 523A (SVOL1 to SVOL3 in the drawing) of the node 520A, and the volume 513B (PVOL4 to PVOL10 in the drawing) is copied to the copy destination volume 523B (SVOL4 to SVOL10) of the node 520B. Since the copy destination volume is distributed to two nodes and the JNLG is installed for each node, the copy source volume 513A belongs to the JNLG 512A, the copy destination volume 523A belongs to a JNLG 522A, the copy source volume 513B belongs to the JNLG 512B, and the copy destination volume 523B belongs to a JNLG 522B. The JNLG 512A and the JNLG 522A are managed as the same JNLG. The JNLG 512B and the JNLG 522B are also managed as the same JNLG. That is, a plurality of JNLGs (JNLG 512A and JNLG 512B) are present in one CTG 511.

The same applies to the CTG 515. A copy source volume 517 belongs to the CTG 515, a volume 517A (PVOL21 to PVOL24 in the drawing) is copied to a copy destination volume 527A (SVOL21 to SVOL24 in the drawing) of the node 520A, and a volume 517B (PVOL25 to PVOL29 in the drawing) is copied to a copy destination volume 527B (SVOL25 to SVOL29) of the node 520B. Since the copy destination volume is distributed to two nodes and the JNLG is installed for each node, the copy source volume 517A belongs to a JNLG 516A, the copy destination volume 527A belongs to a JNLG 526A, the copy source volume 517B belongs to a JNLG 516B, and the copy destination volume 527B belongs to a JNLG 526B. The JNLG 516A and the JNLG 526A are managed as the same JNLG. The JNLG 516B and the JNLG 526B are also managed as the same JNLG. That is, a plurality of JNLGs (JNLG 512A and JNLG 512B) are present in one CTG 511.

When a copy destination volume is created by selecting a node in consideration of a free capacity (of a storage region) of the node at the timing of creating the copy destination volume and a load such as a processor operation rate, a load status of the node changes with the passage of time. Referring to monitoring information on a load of hardware, movement and rearrangement are performed between the nodes of the copy destination volume so as to level a load on JNL processing. The rearrangement of the volume between the nodes for leveling may be an optimal solution, or may reduce the number of nodes to which the copy destination volume is distributed as much as possible. By reducing the number of distributed nodes, the efficiency of the JNL processing can be implemented, and the performance of the system is improved.

The performance of the system can be improved by "arranging the JNLGs belonging to the same CTG in as few nodes as possible while avoiding distribution for the arrangement of the JNLGs belonging to the same CTG" and "changing the arrangement so as to level a processing load for the arrangement of the plurality of CTGs".

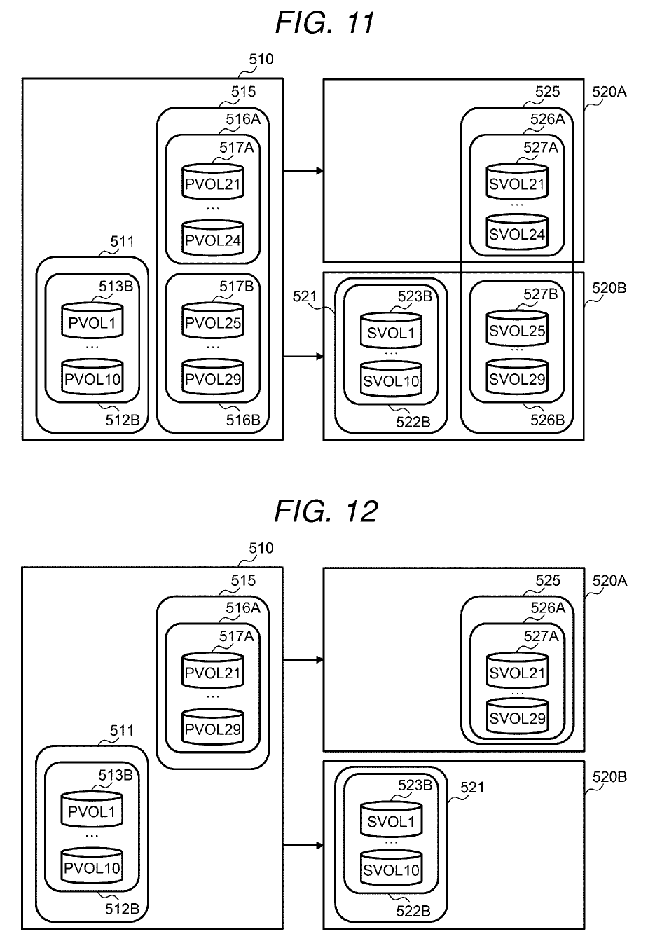

FIGS. 11 and 12 show an example of a case where the copy destination volumes are moved from the configuration of FIG. 10. For the CTG 521, all the copy destination volumes 523A in the node 520A are moved to the node 520B. When the volumes 523A are moved to the node 520B, the volumes 523A belong to the JNLG 522B and the JNLG 522A becomes unnecessary. With the movement of the copy destination volume, the JNLG 512A of the CTG 511 in the storage system 510 is integrated with the JNLG 512B, and the JNLG 512A becomes unnecessary. The unnecessary JNLG is deleted. As described above, the number of JNLGs of the CTG 511 and the CTG 521 can be reduced. In order to move the volume in this manner, it is assumed that the free capacity and the load of the processor are low on the node 520B side and a sufficient margin is left.

The number of nodes of the copy destination volume can be similarly reduced for the CTG 515 and the CTG 525.

As shown in FIG. 12, a volume migration plan for simultaneously performing the volume movement of the CTG 511 and the CTG 521 and the volume movement of the CTG 515 and the CTG 525 can be made. In the movement plan of the volumes belonging to the plurality of CTGs at the same time, depending on a way of processing such as moving one volume at a time, the volumes can be moved even when the free capacity of the node is small, and the number of JNLGs collected in the node is large, so that the performance is improved.

The volumes may be arranged in FIG. 12 through FIGS. 10 and 11, or the volumes may be arranged in FIGS. 10 to 12.

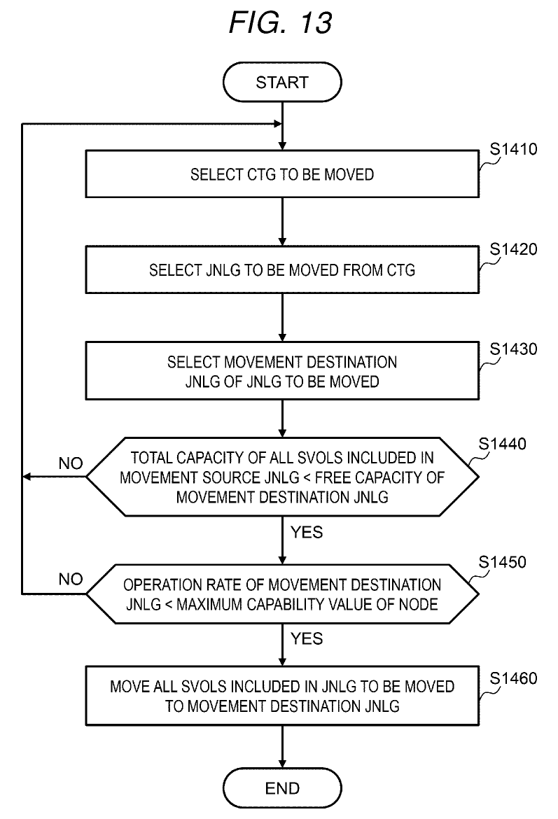

FIG. 13 shows a flowchart of processing of reducing the number of distributed nodes, that is, reducing the number of JNLGs, when the copy destination volume in the CTG is distributed to a plurality of nodes. This processing is executed by the data migration control 330. The data migration control 330 may be a functional unit implemented by a program executed by any CPU shown in FIG. 1, or may be a function executed by a management system, a management apparatus, and a management terminal provided as appropriate.

First, the data migration control 330 selects a CTG to be moved (S1410). Specifically, the data migration control 330 searches for a CTG in which the nodes of the copy destination volume are distributed. As an example, the data migration control 330 refers to the CTG information 420 and selects the CTG ID 421 having a large number of JNLGs 422.

Next, the data migration control 330 selects a JNLG to be moved from among the JNLGs belonging to the selected CTG (S1420). Specifically, the data migration control 330 selects, from among the JNLG IDs 423 of the selected CTG ID 421, a JNLG ID 423 to be moved to another node. For example, the JNLG ID 423 to be moved selects a JNLG ID 423 having a small number of volumes 424 belonging to the JNLG.

Next, the data migration control 330 selects a movement destination JNLG of the JNLG to be moved (S1430). Specifically, the data migration control 330 selects, for example, a JNLG ID 423 having a large number of volumes 424 belonging to the JNLG, from among the JNLG IDs 423 of the selected CTG ID 421 as the movement destination JNLG.

The data migration control 330 determines whether all copy destination volumes belonging to the selected movement source JNLG can be moved to the node of the selected movement destination JNLG.

First, the data migration control 330 refers to the CTG information 420 and calculates a total capacity of all the copy destination volumes belonging to the volume ID 425 of the movement source JNLG ID 423. With reference to the volume information 410, the volume ID 411 corresponding to the volume ID 425 is searched to acquire the capacity 416. Compared to a free capacity of a storage region of a node of the movement destination JNLG, when the total capacity is smaller than the free capacity, it is determined that the target JNLG can be moved (S1440) . When the total capacity is larger than the free capacity, it is determined that the movement is not permitted, and the processing returns to S1410 to select another CTG. Although the processing of returning to S1410 is described in FIG. 13, as another processing method, the processing may return to S1430 to reselect another JNLG as the movement destination JNLG, or the processing may return to S1420 to reselect another JNLG as the JNLG to be moved.

After determining that the target JNLG can be moved, the data migration control 330 next refers to an operation status of the hardware of the movement destination node and an operation rate of the processor, and determines whether an operation rate of a movement destination falls within an allowable range (S1450). For example, when the operation rate is set to 90% as an upper limit in advance, it is determined by simulating whether the operation rate falls within 90% due to an increase in load in the volume movement. When it is determined that the operation rate falls within 90%, the movement is permitted. If not, it is determined that the movement is not permitted, and the processing returns to S1410 to select another CTG. Although the processing of returning to S1410 is described in FIG. 13, as another processing method, the processing may return to S1430 to reselect another JNLG as the movement destination JNLG, or the processing may return to S1420 to reselect another JNLG as the JNLG to be moved.

Here, the value of 90% is an example, and can be variably set. The operation rate may be predicted based on an access frequency of the node.

When the movement is permitted, the data migration control 330 sequentially moves the copy destination volumes of the movement source JNLG to the movement destination JNLG (S1460) .

As another example described above, when there is no volume belonging to the JNLG, the JVOL may be deleted and the JNLG may be deleted.

There is another embodiment. In a DR configuration, a copy destination storage system receives a request to create a copy destination volume and creates a volume, and then the copy destination volume for making replication of a copy source volume creates a relationship between the copy source volume and the copy destination volume. For such processing procedure, when a distributed storage system and the DR configuration are configured, the distributed storage system creates a copy destination volume in a node having a free capacity. By designating a node from a copy source storage system and creating the copy destination volume, it is possible to create a copy destination volume that is not distributed to a plurality of nodes.

The data migration control 330 determines at which timing the processing of reducing the number of nodes to be distributed when the copy destination volume in the CTG in FIG. 13 is distributed to the plurality of nodes, that is, the processing of reducing the number of JNLGs is executed.

The monitor 340 performs processing of monitoring a load on each hardware element of the distributed storage system. The timing of executing the monitoring processing is a time period. The time period can be freely set, and may or may not be a constant period. Information obtained by the monitoring processing is stored in the operation rate 445 and the IO frequency 446 of the node information 440.

The monitoring processing is started from the management apparatus and the storage control 310.

The data migration control 330 refers to the load on the hardware element by the monitor 340, determines a movement destination of a volume, and moves the volume.

In another example, a predicted resource usage rate may be calculated by monitoring the load on the hardware element, and the movement destination of the volume may be determined using the calculated predicted resource usage rate.

As for the timing of executing data migration, a threshold is set for the load on the hardware element such as the operation rate 445 and the IO frequency 446, and the data migration is executed when it is determined that the load is smaller than the threshold, that is, the resource usage rate is low. Further, when it is determined that the load is larger than the threshold, that is, a resource operation rate to the node is biased, the data migration is executed.

As for the timing of executing another data migration, a threshold is set for a free capacity of the node, and the data migration is executed when the free capacity is smaller than the threshold.

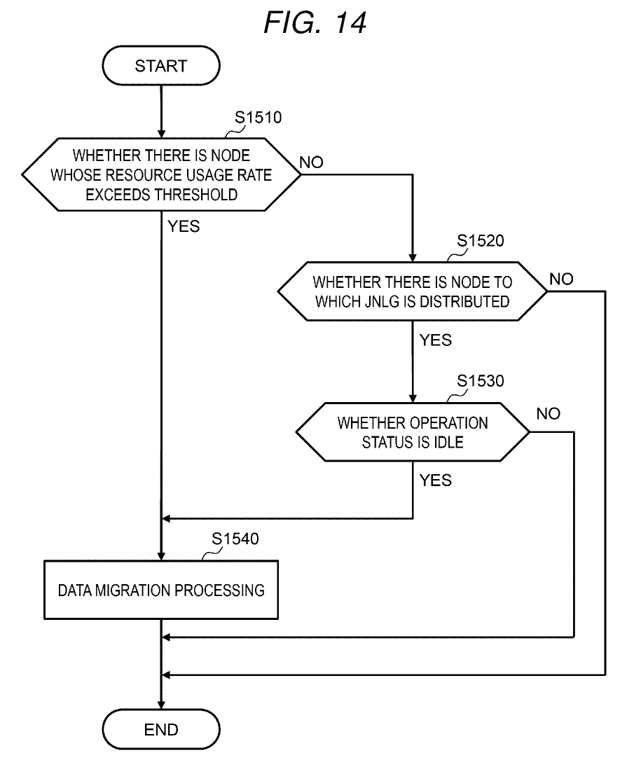

For example, the processing shown in the flowchart of FIG. 14 is performed at a time period that can be designated.

The data migration control 330 determines whether there is a node 220 whose resource usage rate exceeds a preset threshold among the nodes 220 of the distributed storage system (S1510). When there is a node exceeding the threshold, data migration processing (S1540) is performed. When there is no node exceeding the threshold, the data migration control 330 determines whether there is a node to which the JNLG is distributed (S1520). When there is a node to which the JNLG is distributed, the data migration control 330 determines whether the distributed storage system is idle (S1530). That is, it is determined whether the operation is possible even when a load for performing the volume movement processing between nodes by the data migration processing is applied to a hardware resource. If the distributed storage system is idle, the data migration processing (S1540) is performed. When there is no node to which the JNLG is distributed in S1520 or even when there is a node to which the JNLG is distributed in S1520 but the operation status of the node is not idle, the data migration processing is not started and the processing ends.

As described above, in Embodiment 1, when the copy destination volume is distributed to a plurality of nodes in the distributed storage system, the number of distributed nodes is reduced as much as possible, thereby reducing an overhead of JNL processing and improving the performance.

### Embodiment 2

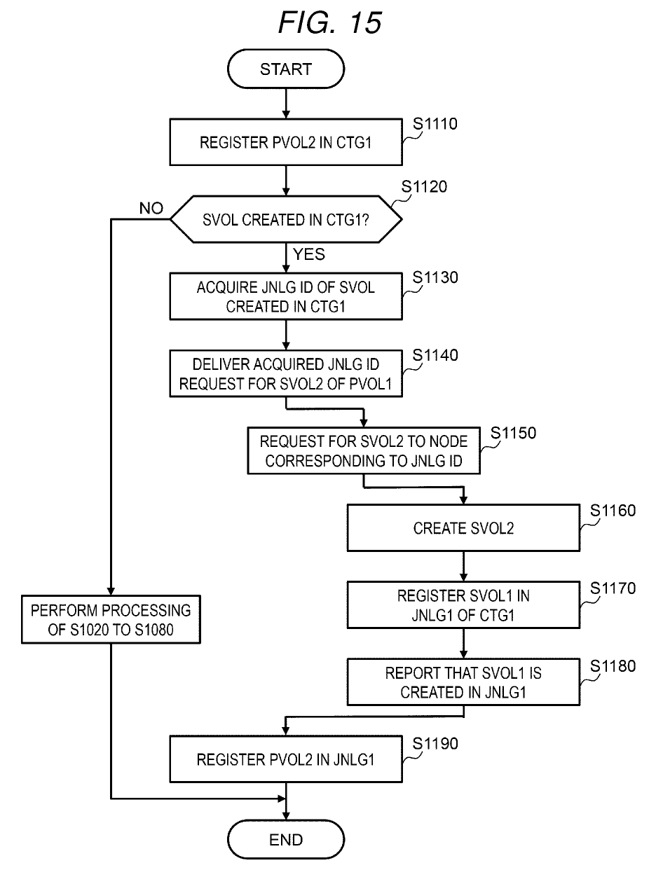

As another embodiment, a method for designating a node for creating an SVOL from a PVOL side is shown in a flowchart of FIG. 15.

First, the copy source storage system 510 registers the PVOL2 in the CTG1 (S1110).

Next, in order to determine in which node of the distributed storage system the SVOL2, which is the copy destination volume of the PVOL2, is created, the storage system 510 determines whether the SVOL has already been created in the same CTG (S1120). When the SVOL has been created in the same CTG1, the storage system 510 acquires a JNLG ID in which the SVOL has been created (S1130). For example, when the PVOL1 (513A) is a DR target volume, the PVOL1 is registered in the CTG1, and the SVOL1 has been created in the JNLG1 of the node 1, the PVOL2 belongs to the CTG1, and thus it is determined that the SVOL is already present.

When the SVOL has already been created, the storage system 510 delivers the acquired JNLG ID and requests the distributed storage system to create the SVOL2 which is a copy destination volume of the DR of the PVOL2 (S1140). When the SVOL is not created, the processing of S1020 to S1080 is performed, and the processing ends.

A compute node of the distributed storage system receives the request and transmits the request to the storage node 522 corresponding to the JNLG ID (S1150).

The node 1 (520A) that has received the request creates the SVOL2 (S1160) and registers the SVOL2 as a copy destination of the PVOL2. The SVOL2 is registered in the JNLG1 in the node (S1170) .

The node 1 reports to the storage system 510 via the compute node that the SVOL2 is created in the JNLG1 (S1180).

The storage system 510 receives the JNLG ID in which the SVOL2 is created, and registers the PVOL2 in the JNLG1 (S1190) .

Here, by sharing information on the JNLG ID between the storage system and the distributed storage system, the node for creating the SVOL is determined such that the SVOL is not distributed to nodes, but this is an example, and other information may be used as long as it is information indicating a node in which the PVOL1 creates the SVOL. Alternatively, the information may be information that allows the compute node of the distributed storage system to search for a node in which the SVOL corresponding to the PVOL1 is created in S1150. In this case, the compute node determines the node, in which the SVOL is created, based on the information received from the storage system.

FIG. 15 shows a case where the PVOL1 belonging to the CTG1 has already created the SVOL1 and the SVOL2 of the PVOL2 belonging to the same CTG1 is created in the same node, but as another embodiment, in a case where the SVOLs of the PVOL1 and the PVOL2 belonging to the CTG1 are created at one time, an SVOL can be created by selecting a node capable of ensuring a free capacity for creating the two SVOLs. In this case, the storage system 510 issues a request instruction to the compute node so as to create SVOLs of a plurality of PVOLs in the same node, determines whether a free capacity can be ensured on the compute node side to determine a node for creating the SVOLs, or determines whether a free capacity can be ensured on the storage system 510 side of the primary site to determine a node. The information for determining whether the free capacity can be secured on the storage system 510 side of the primary site may be obtained from the distributed storage system side or may be obtained from a management apparatus and the like.

In another embodiment, when a load on a specific node of the distributed storage system is high, for example, in a case where a free capacity is smaller than a preset threshold or a hardware operation rate is higher than a preset threshold, it is possible to move a volume from the specific node to another node to improve a performance of the entire system. By moving the volume, a copy destination volume of a certain CTG is distributed to a plurality of nodes, and the number of JNLGs may increase.

As described above, in Embodiment 2, the copy destination volume in the DR environment can be determined and a copy operation can be executed without the user being aware of the nodes of the distributed storage system. Therefore, a degree of freedom of the DR operation of the user is improved.

As described above, the information processing system 1 disclosed in the embodiment includes: a first storage system (primary site 100) including a node that provides a primary volume to a host; and a second storage system (secondary site 200) including a plurality of nodes that hold a secondary volume that is a replication of the primary volume. A consistency holding group (CTG) is formed which is defined such that a plurality of sets of the primary volume and the secondary volume are provided and data in a plurality of the primary volumes written to the plurality of primary volumes with consistency is replicated to a plurality of the secondary volumes with consistency ensured. The replication is performed by journal processing using a first journal volume provided in the same node as the primary volume and a second journal volume provided in the same node as the secondary volume. In the consistency holding group, a first journal group (JNLG) including the primary volume and the first journal volume and a second journal group including the secondary volume and the second journal volume are set, and the journal processing is performed while ensuring consistency of the replication between the first journal group and the second journal group (JNLG). The second journal group is arranged for each node in which the secondary volume of the consistency holding group is arranged. The secondary volume is arranged in each node of the second storage system based on a usage status of a resource of each node of the second storage system and the number of nodes in which the secondary volume in the consistency holding group is arranged.

Specifically, the plurality of secondary volumes are arranged in the plurality of nodes such that the number of the second journal groups is reduced.

According to this configuration and operation, the performance can be improved by limiting the distribution of the copy destination volume.

The first journal group is provided corresponding to the second journal group, so that one or a plurality of the first journal groups are arranged in one node.

The second journal volume is arranged for each node in which the secondary volume of the consistency holding group is arranged, and is used for the journal processing to one or a plurality of the secondary volumes arranged in the node. The first journal volume is provided corresponding to the second journal volume, so that one or a plurality of the first journal volumes are arranged in one node.

According to this configuration and operation, since the number of journal groups is determined according to the number of nodes to which the secondary volumes are arranged, the number of journal groups can be reduced by the rearrangement of the secondary volumes, and the performance can be improved.

Specifically, the number of journal groups and the number of journal volumes are reduced by moving the secondary volume to a node in which another secondary volume of the same consistency holding group is arranged.

The number of the second journal groups and the number of the second journal volumes are reduced by moving the secondary volume between the nodes, and the number of the corresponding first journal groups and the number of the corresponding first journal volumes are reduced by reducing the number of the second journal groups and the number of the second journal volumes.

According to this configuration and operation, the performance can be improved by the rearrangement of the secondary volumes in the consistency holding group.

The information processing system 1 includes a plurality of the consistency holding groups. A plurality of the secondary volumes of the plurality of consistency holding groups are arranged in a plurality of nodes of the second storage system based on resources of nodes of the second storage system.

The number of the journal groups and the number of the journal volumes are reduced by moving the plurality of secondary volumes to be aggregated to the same node for each of the plurality of consistency holding groups.

Whether the secondary volume is movable to a node, in which another secondary volume of the same consistency holding group is arranged, is determined based on the resource of the node, and the secondary volume is moved when it is determined that the secondary volume is movable.

According to this configuration and operation, the movement destination node can be appropriately selected in consideration of the state of each node.

When a primary volume and the secondary volume are created to belong to the consistency holding group, the information processing system 1 creates the secondary volume to be created in a node in which the secondary volume of the same consistency holding group is arranged.

According to this configuration and operation, a situation in which the journal groups are distributed can be avoided in advance.

The invention is not limited to the above-described embodiments and includes various modifications. For example, the above-described embodiments have been described in detail to facilitate understanding of the invention, and the invention is not necessarily limited to those including all the configurations described above. The configurations may not only be deleted, but also be replaced or added.

What is claimed is:

1. An information processing system comprising:
a first storage system including a node that provides a primary volume to a host; and
a second storage system including a plurality of nodes that hold a secondary volume that is a replication of the primary volume, wherein a consistency holding group is formed which is defined such that a plurality of sets of the primary volume and the secondary volume are provided and data in a plurality of the primary volumes written to the plurality of primary volumes with consistency is replicated to a plurality of the secondary volumes with consistency ensured,
the replication is performed by journal processing using a first journal volume provided in the same node as the primary volume and a second journal volume provided in the same node as the secondary volume,
in the consistency holding group, a first journal group including the primary volume and the first journal volume and a second journal group including the secondary volume and the second journal volume are set, and the journal processing is performed while ensuring consistency of the replication between the first journal group and the second
journal group, the second journal group is arranged for each node in which the secondary volume of the consistency holding group is arranged, and the secondary volume is arranged in each node of the second storage system based on a usage status of a resource of each node of the second storage system and the number of nodes in which the secondary volume in the consistency holding group is arranged.

2. The information processing system according to claim 1, wherein the plurality of secondary volumes are arranged in the plurality of nodes such that the number of the second journal groups is reduced.

3. The information processing system according to claim 1, wherein the first journal group is provided corresponding to the second journal group, so that one or a plurality of the first journal groups are arranged in one node.

4. The information processing system according to claim 3, wherein
the second journal volume is arranged for each node in which the secondary volume of the consistency holding group is arranged, and is used for the journal processing to one or a plurality of the secondary volumes arranged in the node, and the first journal volume is provided corresponding to the second journal volume, so that one or a plurality of the first journal volumes are arranged in one node.

5. The information processing system according to claim 4, wherein the number of journal groups and the number of journal volumes are reduced by moving the secondary volume to a node in which another secondary volume of the same consistency holding group is arranged.

6. The information processing system according to claim 5, wherein the number of the second journal groups and the number of the second journal volumes are reduced by moving the secondary volume between the nodes, and
the number of the corresponding first journal groups and the number of the corresponding first journal volumes are reduced by reducing the number of the second journal
groups and the number of the second journal volumes.

7. The information processing system according to claim 3, comprising:
a plurality of the consistency holding groups, wherein a plurality of the secondary volumes of the plurality of consistency holding groups are arranged in a plurality of nodes of the second storage system based on resources of nodes of the second storage system.

8. The information processing system according to claim 7, wherein the number of the journal groups and the number of the journal volumes are reduced by moving the plurality of secondary volumes to be aggregated to the same node for each of the plurality of consistency holding groups.

9. The information processing system according to claim 7, wherein whether the secondary volume is movable to a node, in which another secondary volume of the same consistency holding group is arranged, is determined based on the resource of the node, and the secondary volume is moved when it is determined that the secondary volume is movable.

10. The information processing system according to claim 1, wherein when a primary volume and the secondary volume are created to belong to the consistency holding group, the secondary volume to be created is created in a node in which the secondary volume of the same consistency holding group is arranged.

11. A method for controlling an information processing system, the information processing system including a first storage system including a node that provides a primary volume to a host and a second storage system including a plurality of nodes that hold a secondary volume that is a replication of the primary volume, the method comprising:
forming a consistency holding group which is defined such that a plurality of sets of the primary volume and the secondary volume are provided and data in a plurality of the primary volumes written to the plurality of primary volumes with consistency is replicated to a plurality of the secondary volumes with consistency ensured, wherein the replication is performed by journal processing using a first journal volume provided in the same node as the primary volume and a second journal volume provided in
the same node as the secondary volume, in the consistency holding group, a first journal group including the primary volume and the first journal volume and a second journal group including the secondary volume and the second journal volume are set, and the journal processing is performed while ensuring consistency of the replication between the first journal group and the second journal group, the second journal group is arranged for each node in which the secondary volume of the consistency holding group is arranged, and the secondary volume is arranged in each node of the second storage system based on a usage status of a resource of each node of the second storage system and the number of nodes in which the secondary volume is arranged in the consistency holding group.
